(19) United States
(12) Patent Application Publication
(10) Pub. No.: US 2025/0384673 A1
(43) Pub. Date: Dec. 18, 2025

(54) TEST METHOD AND SYSTEM FOR INTELLIGENT SENSING SYSTEM, AND ELECTRONIC DEVICE

(71) Applicant: NATIONAL INSTITUTE OF METROLOGY, CHINA, Chaoyang District, Beijing (CN)

(72) Inventors: Haiyong Gan, Chaoyang District, Beijing (CN); Wende Liu, Chaoyang District, Beijing (CN); Guojin Feng, Chaoyang District, Beijing (CN); Yingwei He, Chaoyang District, Beijing (CN)

(21) Appl. No.: 18/879,958

(22) PCT Filed: Aug. 23, 2023
(86) PCT No.: PCT/CN2023/114408

§ 371 Date: Dec. 30, 2024

(30) Foreign Application Priority Data
Dec. 15, 2022 (CN) 202211617237.5

(51) Int. Cl. G06V 10/776

(52) U.S. Cl. CPC G06V 10/776

(57) ABSTRACT

An intelligent sensing system can output an identification result about a target on the basis of input data to be identified, the data comprising a scene and the target included in the scene. An intelligent sensing method involves: acquiring a plurality of test samples each including a score value, a label, and first data of the sample; for each sample, determining whether an identification result is correct to obtain a first grade; summing the first grades of all the samples, and dividing the sum by a sum of the score values of all the samples to obtain a second grade for evaluating the sensing capability of the intelligent sensing system. An objective quantitative score can be given to the identification capability of the intelligent sensing system, and the identification capability of the intelligent sensing system can be comprehensively investigated with respect to various scene types.

### CROSS-REFERENCE TO RELATED APPLICATIONS

This application is a national phase entry under 35 U.S.C. § 371 of International Patent Application PCT/CN2023/114408, filed Aug. 23, 2023, designating the United States of America and published as International Patent Publication WO 2024/124957 A1 on Jun. 20, 2024, which claims the benefit under Article 8 of the Patent Cooperation Treaty of Chinese Patent Application Serial No. 202211617237.5, filed Dec. 15, 2022, titled “Test Method and System for Intelligent Sensing System, and Electronic Device,” which is hereby incorporated herein by this reference in its entirety.

### TECHNICAL FIELD

The present disclosure relates to the field of testing and, in particular, to a method and test system for an intelligent sensing system, and an electronic device.

### BACKGROUND

An intelligent sensing system may recognize specific targets, which are widely used in many fields. For example, in the field of surveillance, an intelligent sensing system can quickly obtain specific target people based on a video obtained by a camera. With the development of neural networks and computer hardware, capabilities of intelligent sensing systems have rapidly improved, and their application scope has expanded to all professions and trades. However, in a specific scenario having requirements, it is difficult to know whether a sensing capability of an intelligent sensing system can meet the needs. Therefore, it is necessary to make an accurate assessment of the sensing capability of the intelligent sensing system.

The information disclosed in this background section is only intended to deepen the understanding of the overall background of the present disclosure, and should not be regarded as an admission or any form of suggestion that the information constitutes related art known to those skilled in the art.

### BRIEF SUMMARY

In view of the problems in the related art, the present disclosure provides a method and test system for an intelligent sensing system, and an electronic device.

The present disclosure provides a test method for an intelligent sensing system, where the intelligent sensing system outputs a recognition result about a target based on to-be-recognized data input into the intelligent sensing system, the to-be-recognized data includes a scenario and the target included in the scenario, and the method includes:
obtaining a plurality of test samples, where each sample includes a score, a label and first data corresponding to the sample;
performing the following steps on each sample:
   a. performing scenario presentation on the first data to form to-be-recognized second data;
   b. inputting the second data into the intelligent sensing system to obtain a recognition result output from the intelligent sensing system; and
   c. comparing the recognition result with the label to determine whether the recognition result is correct: in case that the recognition result is correct, taking the score as a first grade corresponding to a current sample from the intelligent sensing system; or in case that the recognition result is incorrect, taking zero as a first grade corresponding to a current sample from the intelligent sensing system; and
dividing a sum of first grades corresponding to all samples by a sum of scores corresponding to all samples to obtain a second grade, where the second grade is used to evaluate a sensing capability of the intelligent sensing system.

According to the test method for the intelligent sensing system provided by the present disclosure, obtaining the plurality of test samples includes:
obtaining basic first data, and setting a basic label and a basic score to form a basic sample; and
generating expansive first data by inputting the basic first data into a data generator and setting an expansive label and an expansive score to form an expansive sample.

According to the test method for the intelligent sensing system provided by the present disclosure, setting the expansive score includes:
obtaining a validity of the data generator; and
taking a product of the validity and the basic score as the expansive score.

According to the test method for the intelligent sensing system provided by the present disclosure, for the plurality of test samples, different scores are set for the samples based on type differences of the samples.

According to the test method for the intelligent sensing system provided by the present disclosure, the method further includes:
classifying the samples based on scores corresponding to the samples; and
for samples of different categories, evaluating sensing capabilities of the intelligent sensing system for samples under different categories in an ascending order of the scores to a highest score.

According to the test method for the intelligent sensing system provided by the present disclosure, the method further includes:
for a first batch of test samples, obtaining a second grade corresponding to the first batch;
adding a test sample to the first batch of test samples to form a second batch of test samples;
for a second batch of test samples, obtaining a second grade corresponding to the second batch; and
in case that the second grade corresponding to the second batch is equal to the second grade corresponding to the first batch, evaluating the sensing capability of the intelligent sensing system by using the second grade corresponding to the second batch; or in case that the second grade corresponding to the second batch is not equal to the second grade corresponding to the first batch, determining that scoring of the sensing capability of the intelligent sensing system is unstable, and continuously adding a test sample for re-scoring.

According to the test method for the intelligent sensing system provided by the present disclosure, the first data includes a scenario-based real image; and
correspondingly, performing the scenario presentation includes:
   obtaining all physical objects in the scenario, combining all physical objects based on the real image, and providing combined physical objects to the intelligent sensing system for being recognized; and/or
   providing the real image directly to the intelligent sensing system for being recognized; and/or
obtaining part of the physical objects in the scenario, supplementing remaining physical objects through a virtual reality technology, and providing supplemented physical objects to the intelligent sensing system for being recognized.

The present disclosure further provides a test system for an intelligent sensing system, where the intelligent sensing system outputs a recognition result about a target based on to-be-recognized data input into the intelligent sensing system, the to-be-recognized data includes a scenario and the target included in the scenario, and the system includes:

a sample module, used for obtaining a plurality of test samples, where each sample includes a score, a label and first data corresponding to the sample;
a loop module, used for performing the following steps on each sample:
   a. performing scenario presentation on the first data to form to-be-recognized second data;
   b. inputting the second data into the intelligent sensing system to obtain a recognition result output from the intelligent sensing system; and
   c. comparing the recognition result with the label to determine whether the recognition result is correct: in case that the recognition result is correct, taking the score as a first grade corresponding to a current sample from the intelligent sensing system; or in case that the recognition result is incorrect, taking zero as a first grade corresponding to a current sample from the intelligent sensing system; and
an evaluation module, used for dividing a sum of first grades corresponding to all samples by a sum of scores corresponding to all samples to obtain a second grade, where the second grade is used to evaluate a sensing capability of the intelligent sensing system.

The present disclosure further provides an electronic device, including a memory, a processor, and a computer program stored on the memory and executable on the processor, where the processor, when executing the program, performs the steps of the test method for the intelligent sensing system described above.

The present disclosure further provides a non-transitory computer-readable storage medium having a computer program stored thereon, where the computer program, when executed by a processor, the steps of the test method for the intelligent sensing system described above.

In the method and the test system for the intelligent sensing system, and the electronic device provided by the present disclosure, an objectively quantitative grade for the sensing capability of the intelligent sensing system may be obtained. In addition, by adopting scenario-based test samples, the test samples are easy to be expanded and obtained, and the sensing capability of the intelligent sensing system may be comprehensively examined from various scenario type levels.

### BRIEF DESCRIPTION OF THE DRAWINGS

In order to illustrate the solutions in the embodiments of the present disclosure or in the related art more clearly, the drawings used in the description of the embodiments or the related art are briefly described below. The drawings in the following description are only some embodiments of the present disclosure, and other drawings may be obtained based on these drawings without any creative work for those skilled in the art.

FIG. 1 is a schematic flow chart of a test method for an intelligent sensing system according to the present disclosure;

FIG. 2 is a schematic flow chart of testing an intelligent sensing system according to the present disclosure;

FIG. 3 is a schematic structural diagram of a test system for an intelligent sensing system according to the present disclosure; and

FIG. 4 is a schematic structural diagram of an electronic device according to an embodiment of the present disclosure.

### DETAILED DESCRIPTION

To illustrate the objectives, solutions and advantages of the disclosure, the solutions in the present disclosure are described clearly and completely below in conjunction with the drawings in the disclosure. The described embodiments are part of the embodiments of the disclosure, not all of them. All other embodiments obtained by a person of ordinary skill in the art based on the embodiments of the present disclosure without creative effort belong to the scope of the present disclosure.

A test method for an intelligent sensing system provided by embodiments of the present disclosure is described in detail in conjunction with the drawings through specific embodiments and their application scenarios.

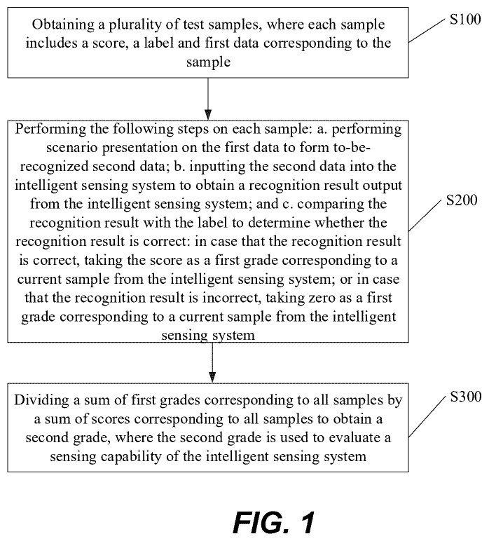

FIG. 1 is a schematic flow chart of a test method for an intelligent sensing system according to the present disclosure. As shown in FIG. 1, in the test method for the intelligent sensing system provided by the present disclosure, the intelligent sensing system outputs a recognition result about a target based on to-be-recognized data input into the intelligent sensing system, the to-be-recognized data includes a scenario and a target included in the scenario, and the method includes the following steps.

Preferably, the present disclosure is applicable to the field of image processing, that is, the to-be-recognized data is in image format.

Preferably, the present disclosure is applicable to the field of sound processing, that is, the to-be-recognized data is in audio format.
S100: obtaining a plurality of test samples, where each sample includes a score, a label and first data corresponding to the sample.

Optionally, obtaining the plurality of test samples includes:
obtaining basic first data, and setting a basic label and a basic score to form a basic sample; and
generating expansive first data by inputting the basic first data into a data generator and setting an expansive label and an expansive score to form an expansive sample.

Preferably, the data generator may synthesize virtual third space-time feature data based on physical first space-time feature data and physical second space-time feature data. The first space-time feature data includes a first target and a first background, the second space-time feature data includes a second target and a second background, and the third space-time feature data includes the first target and the second background.

Optionally, setting the expansive score includes:
obtaining a validity of the data generator; and
taking a product of the validity and the basic score as the expansive score.

Preferably, the validity of the data generator is in an interval [0, 1]. For example, in case that the validity is 0.8, and the basic score of a basic sample i is 10, the expansive score of an expansive sample j obtained based on the basic sample i by the data generator is 8.

Optionally, different scores are set for the plurality of test samples based on type differences of the samples.

Preferably, the samples may be distinguished by types (difficulty, complexity, etc.), and different scores may be assigned to different samples.
S200: performing the following steps on each sample:
   a. performing scenario presentation on the first data to form to-be-recognized second data;
   b. inputting the second data into the intelligent sensing system to obtain a recognition result output from the intelligent sensing system; and
   c. comparing the recognition result with the label to determine whether the recognition result is correct: in case that the recognition result is correct, taking the score as a first grade corresponding to a current sample from the intelligent sensing system; or in case that the recognition result is incorrect, taking zero as a first grade corresponding to a current sample from the intelligent sensing system.
S300: dividing a sum of first grades corresponding to all samples by a sum of scores corresponding to all samples to obtain a second grade, where the second grade is used to evaluate a sensing capability of the intelligent sensing system.

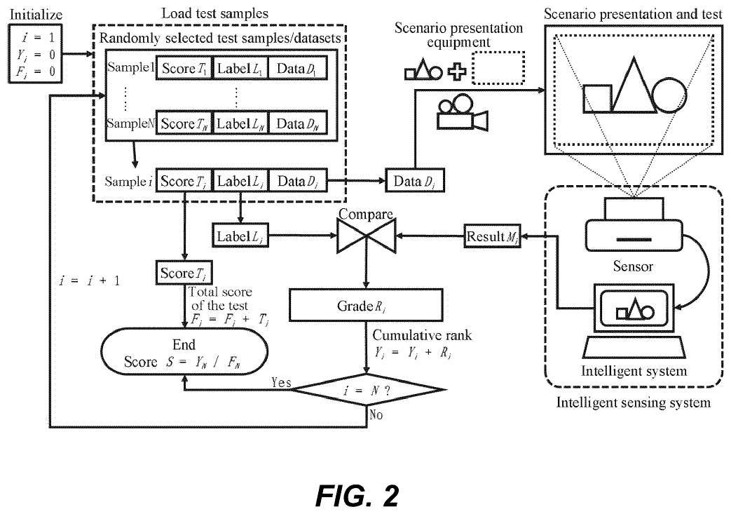

FIG. 2 is a schematic flow chart of testing an intelligent sensing system according to the present disclosure. As shown in FIG. 2, N samples are traversed. A grade Ri (i.e., the first grade) is obtained for each sample. The sum of the first grades corresponding to all samples is divided by the sum of the scores corresponding to the samples to obtain the second grade S.

In the present disclosure, an objectively quantitative grade for the sensing capability of the intelligent sensing system may be obtained. In addition, by adopting scenario-based test samples, the test samples are easy to be expanded and obtained, and the sensing capability of the intelligent sensing system may be comprehensively examined from various scenario type levels.

Optionally, the method further includes:
classifying the samples based on scores corresponding to the samples; and
for samples of different categories, evaluating sensing capabilities of the intelligent sensing system for samples under different categories in an ascending order of the scores to a highest score.

Preferably, the test samples may be scored based on the difficulty. A test sample is tested and scored from a simple level to a difficult level, and a difficult test is performed on the test sample after the test sample passes a simple level. The level of the intelligent sensing system is, therefore, determined.

Optionally, the method further includes:
for a first batch of test samples, obtaining a second grade corresponding to the first batch;
adding a test sample to the first batch of test samples to form a second batch of test samples;
for a second batch of test samples, obtaining a second grade corresponding to the second batch; and
in case that the second grade corresponding to the second batch is equal to the second grade corresponding to the first batch, evaluating the sensing capability of the intelligent sensing system by using the second grade corresponding to the second batch; or in case that the second grade corresponding to the second batch is not equal to the second grade corresponding to the first batch, determining that scoring of the sensing capability of the intelligent sensing system is unstable, and continuously adding a test sample for re-scoring.

The number of test samples is appropriately increased. In case that the second grade is stable and the number of test samples is no longer increased, the second grade is taken as a final score.

Optionally, the first data includes a scenario-based real image.

Correspondingly, performing the scenario presentation includes:
obtaining all physical objects in the scenario, combining all physical objects based on the real image, and providing combined physical objects to the intelligent sensing system for being recognized; and/or,
providing the real image directly to the intelligent sensing system for being recognized; and/or,
obtaining part of the physical objects in the scenario, supplementing remaining physical objects through a virtual reality technology, and providing supplemented physical objects to the intelligent sensing system for being recognized.

Preferably, the first data may also be a video, and may be further extended to other data in the optical field.

Preferably, the first data may also be data in the acoustic field, for example, the intelligent sensing system is indicated to simulate auditory sensation and distinguish the heard sound. The first data may also be data in the chemical field, for example, the intelligent sensing system is indicated to simulate smell and distinguish the smell of gas. The first data may also be data in the mechanical field, for example, the intelligent sensing system is indicated to simulate touch and distinguish the source of a power. The first data may also be data in the biochemical field, for example, the intelligent sensing system is indicated to simulate taste and distinguish the taste of substances. Correspondingly, the second data is obtained by performing scenario presentation on the first data. The scenario presentation process may be considered as adding various interference factors of the same type to the first data or adding noise that affects the distinguish of the intelligent sensing system.

A test system for an intelligent sensing system provided by the present disclosure is described below. The test system for the intelligent sensing system described below and the test method for the intelligent sensing system described above can be referred to each other.

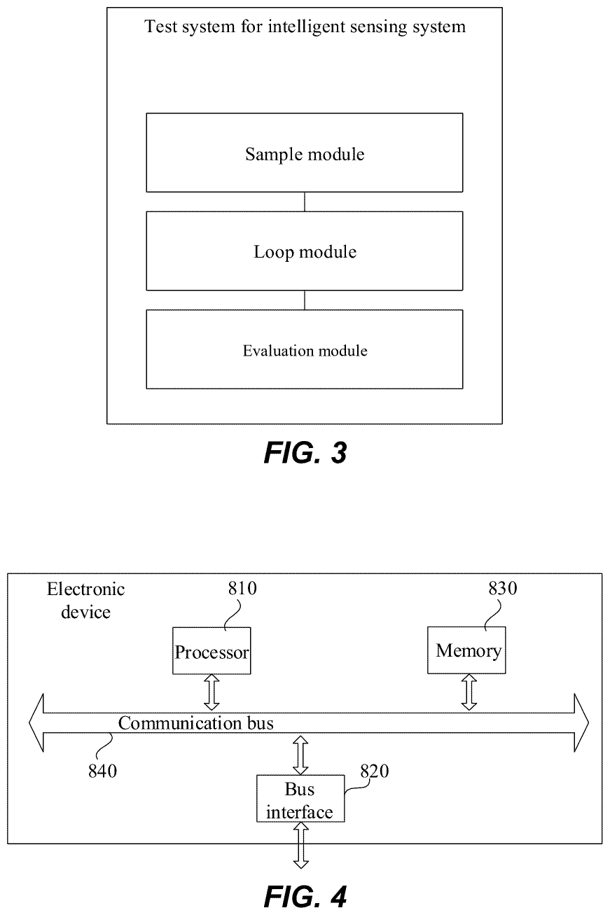

FIG. 3 is a schematic structural diagram of a test system for an intelligent sensing system according to the present disclosure. As shown in FIG. 3, the present disclosure further provides the test system for the intelligent sensing system, where the intelligent sensing system outputs a recognition result about a target based on to-be-recognized data input into the intelligent sensing system, the to-be-recognized data includes a scenario and a target included in the scenario, and the system includes the following modules.

A sample module is used for obtaining a plurality of test samples, where each sample includes a score, a label and first data corresponding to the sample.

A loop module is used for performing the following steps on each sample:
a. performing scenario presentation on the first data to form to-be-recognized second data;
b. inputting the second data into the intelligent sensing system to obtain a recognition result output from the intelligent sensing system; and
c. comparing the recognition result with the label to determine whether the recognition result is correct: in case that the recognition result is correct, taking the score as a first grade corresponding to a current sample from the intelligent sensing system; or in case that the recognition result is incorrect, taking zero as a first grade corresponding to a current sample from the intelligent sensing system.

An evaluation module is used for dividing a sum of first grades corresponding to all samples by a sum of scores corresponding to all samples to obtain a second grade, where the second grade is used to evaluate a sensing capability of the intelligent sensing system.

In this embodiment, an objectively quantitative grade for the sensing capability of the intelligent sensing system may be obtained. In addition, by adopting scenario-based test samples, the test samples are easy to be expanded and obtained, and the sensing capability of the intelligent sensing system may be comprehensively examined from various scenario type levels.

FIG. 4 is a schematic structural diagram of an electronic device according to an embodiment of the present disclosure. As shown in FIG. 4, the electronic device may include a processor 810, a communication interface 820, a memory 830 and a communication bus 840. The processor 810, the communication interface 820, and the memory 830 communicate with each other through the communication bus 840. The processor 810 may call logic instructions in the memory 830 to perform a test method for an intelligent sensing system, where the intelligent sensing system outputs a recognition result about a target based on to-be-recognized data input into the intelligent sensing system, the to-be-recognized data includes a scenario and the target included in the scenario, and the method includes:
obtaining a plurality of test samples, where each sample includes a score, a label and first data corresponding to the sample;
performing the following steps on each sample:
   a. performing scenario presentation on the first data to form to-be-recognized second data;
   b. inputting the second data into the intelligent sensing system to obtain a recognition result output from the intelligent sensing system; and
   c. comparing the recognition result with the label to determine whether the recognition result is correct: in case that the recognition result is correct, taking the score as a first grade corresponding to a current sample from the intelligent sensing system; or in case that the recognition result is incorrect, taking zero as a first grade corresponding to a current sample from the intelligent sensing system; and
dividing a sum of first grades corresponding to all samples by a sum of scores corresponding to all samples to obtain a second grade, where the second grade is used to evaluate a sensing capability of the intelligent sensing system.

In addition, the logic instructions in the memory 830 described above may be performed in the form of a software functional unit and may be stored in a computer readable storage medium while being sold or used as a separate product. Based on such understanding, the solution of the present disclosure or a part of the solution, which is essential or contributes to the related art, may be embodied in the form of a software product, which is stored in a storage medium, including several instructions to cause a computer device (which may be a personal computer, server, or network device, etc.) to perform all or part of the steps of the methods described in various embodiments of the present disclosure. The storage medium described above includes: a U disk, a mobile hard disk, a read-only memory (ROM), a random-access memory (RAM), a magnetic disk, or an optical disk, and the like.

The present disclosure further provides a computer program product, where the computer program product includes a computer program stored on a non-transitory computer-readable storage medium, the computer program includes a program instruction, when executed by a computer, the computer may perform the test method for the intelligent sensing system provided above, where the intelligent sensing system outputs a recognition result about a target based on to-be-recognized data input into the intelligent sensing system, the to-be-recognized data includes a scenario and the target included in the scenario, and the method includes:
obtaining a plurality of test samples, where each sample includes a score, a label and first data corresponding to the sample;
performing the following steps on each sample:
   a. performing scenario presentation based on the first data to form to-be-recognized second data;
   b. inputting the second data into the intelligent sensing system to obtain a recognition result output from the intelligent sensing system; and
   c. comparing the recognition result with the label to determine whether the recognition result is correct: in case that the recognition is correct, taking the score as a first grade of the intelligent sensing system for a current sample; or in case that the recognition is incorrect, taking zero as a first grade of the intelligent sensing system for a current sample; and
dividing a sum of first grades of all samples by a sum of scores of all samples to obtain a second grade, where the second grade is used to evaluate a sensing capability of the intelligent sensing system.

The present disclosure further provides a non-transitory computer-readable storage medium storing a computer program, the computer program, when executed by a processor, performs the test method for the intelligent sensing system provided above, where the intelligent sensing system outputs a recognition result about a target based on to-be-recognized data input into the intelligent sensing system, the to-be-recognized data includes a scenario and the target included in the scenario, and the method includes:
obtaining a plurality of test samples, where each sample includes a score, a label and first data corresponding to the sample;
performing the following steps on each sample:
   a. performing scenario presentation on the first data to form to-be-recognized second data;
   b. inputting the second data into the intelligent sensing system to obtain a recognition result output from the intelligent sensing system; and
   c. comparing the recognition result with the label to determine whether the recognition result is correct: in case that the recognition result is correct, taking the score as a first grade corresponding to a current sample from the intelligent sensing system; or in case that the recognition result is incorrect, taking zero as a first grade corresponding to a current sample from the intelligent sensing system; and
dividing a sum of first grades corresponding to all samples by a sum of scores corresponding to all samples to obtain a second grade, where the second grade is used to evaluate a sensing capability of the intelligent sensing system.

The device embodiments described above are merely illustrative, where the units described as separate components may or may not be physically separate, and the components displayed as units may or may not be physical units, that is, may be located at the same place or be distributed to plurality of network units. Some or all of the modules may be selected according to actual needs to achieve the purpose of the solution of the present embodiment. Those skilled in the art may understand and implement the embodiments described above without paying creative labors.

Through the description of the embodiments above, those skilled in the art can clearly understand that the various embodiments can be implemented by means of software and a necessary general hardware platform, and of course, by hardware. Based on such understanding, the solution of the present disclosure or a part of the solution, which is essential or contributes to the related art, may be embodied in the form of a software product, which is stored in a storage medium such as ROM/RAM, magnetic Discs, optical discs, etc., including several instructions to cause a computer device (which may be a personal computer, server, or network device, etc.) to perform various embodiments or a part of the methods described in various embodiments.

It should be noted that the above embodiments are only used to explain the solutions of the present disclosure, and are not limited thereto; although the present disclosure has been described in detail with reference to the foregoing embodiments, it should be understood by those skilled in the art that modifications to the solutions documented in the foregoing embodiments and equivalent substitutions to a part of the features may be made and these modifications and substitutions do not make the essence of the corresponding solutions depart from the scope of the solutions of various embodiments of the present disclosure.

1.-10. (canceled)

11. A test method for an intelligent sensing system, wherein the intelligent sensing system outputs a recognition result about a target based on to-be-recognized data input into the intelligent sensing system, the to-be-recognized data comprises a scenario and the target included in the scenario, and the method comprises:
obtaining a plurality of test samples, wherein each sample comprises a score, a label and first data corresponding to the sample;
performing the following steps on each sample:
a. a performing scenario presentation on the first data to form to-be-recognized second data;
b. inputting the to-be-recognized second data into the intelligent sensing system to obtain a recognition result output from the intelligent sensing system; and
c. comparing the recognition result with the label to determine whether the recognition result is correct: in case that the recognition result is correct, taking the score as a first grade corresponding to a current sample from the intelligent sensing system; or in case that the recognition result is incorrect, taking zero as a first grade corresponding to a current sample from the intelligent sensing system; and
dividing a sum of first grades corresponding to all samples by a sum of scores corresponding to all samples to obtain a second grade, wherein the second grade is used to evaluate a sensing capability of the intelligent sensing system.

12. The test method of claim 11, wherein obtaining the plurality of test samples comprises:
obtaining basic first data, and setting a basic label and a basic score to form a basic sample; and
generating expansive first data by inputting the basic first data into a data generator and setting an expansive label and an expansive score to form an expansive sample.

13. The test method of claim 12, wherein setting the expansive score comprises:
obtaining a validity of the data generator; and
taking a product of the validity and the basic score as the expansive score.

14. The test method of claim 11, wherein different scores are set for the plurality of test samples based on type differences of the samples.

15. The test method of claim 11, further comprising:
classifying the samples based on scores corresponding to the samples; and
for samples of different categories, evaluating sensing capabilities of the intelligent sensing system for samples under different categories in an ascending order of the scores.

16. The test method of claim 11, further comprising:
for a first batch of test samples, obtaining a second grade corresponding to the first batch;
adding a test sample to the first batch of test samples to form a second batch of test samples;
for a second batch of test samples, obtaining a second grade corresponding to the second batch; and
in case that the second grade corresponding to the second batch is equal to the second grade corresponding to the first batch, evaluating the sensing capability of the intelligent sensing system by using the second grade corresponding to the second batch; or in case that the second grade corresponding to the second batch is not equal to the second grade corresponding to the first batch, determining that scoring of the sensing capability of the intelligent sensing system is unstable, and continuously adding a test sample for re-scoring.

17. The test method of claim 11, wherein the first data comprises a scenario-based real image; and
wherein performing the scenario presentation comprises:
obtaining all physical objects in the scenario, combining all physical objects based on the real image, and providing combined physical objects to the intelligent sensing system for identification; and/or
providing the real image directly to the intelligent sensing system for identification; and/or
obtaining part of the physical objects in the scenario, supplementing remaining physical objects through a virtual reality technology, and providing supplemented physical objects to the intelligent sensing system for identification.

18. A test system for an intelligent sensing system, wherein the intelligent sensing system is capable of outputting a recognition result about a target based on to-be-recognized data input into the intelligent sensing system, the to-be-recognized data comprises a scenario and the target included in the scenario, and the intelligent sensing system comprises:
a sample module, used for obtaining a plurality of test samples, wherein each sample comprises a score, a label and first data corresponding to the sample;
a loop module, used for performing the following steps on each sample:
a. performing scenario presentation on the first data to form to-be-recognized second data;
b. inputting the to-be-recognized second data into the intelligent sensing system to obtain a recognition result output from the intelligent sensing system; and
c. comparing the recognition result with the label to determine whether the recognition result is correct: in case that the recognition result is correct, taking the score as a first grade corresponding to a current sample from the intelligent sensing system; or in case that the recognition result is incorrect, taking zero as a first grade corresponding to a current sample from the intelligent sensing system; and
an evaluation module, used for dividing a sum of first grades corresponding to all samples by a sum of scores corresponding to all samples to obtain a second grade, wherein the second grade is used to evaluate a sensing capability of the intelligent sensing system.

19. An electronic device, comprising a memory, a processor and a computer program stored in the memory and executable in the processor, wherein the processor, when executing the computer program, performs steps of a test method for an intelligent sensing system of claim 11.

20. A non-transitory computer-readable storage medium having a computer program stored thereon, wherein the computer program, when executed by a processor, performs steps of a test method for an intelligent sensing system of claim 11.
